(19) United States
(12) Patent Application Publication
(10) Pub. No.: US 2026/0260212 A1
(43) Pub. Date: Sep. 3, 2026

(54) ORDER PROCESSING SYSTEM AND ORDER PROCESSING METHOD PERFORMED IN ORDER PROCESSING SYSTEM

(71) Applicant: GLORY LTD., Himeji-shi (JP)

(72) Inventors: Daisuke SATO, Himeji-shi (JP); Tomo ABE, Himeji-shi (JP)

(73) Assignee: GLORY LTD., Himeji-shi (JP)

(21) Appl. No.: 19/543,919

(22) Filed: Feb. 19, 2026

(30) Foreign Application Priority Data
Mar. 3, 2025 (JP) 2025-032738

(51) Int. Cl. G06Q 10/087; G06Q 50/12

(52) U.S. Cl. CPC G06Q 10/0874; G06Q 50/12

(57) ABSTRACT

An order processing system includes: an order receiver configured or programmed to receive an order from a customer; a first person information obtainer configured or programmed to obtain first person information for identifying the customer; a position information obtainer configured or programmed to obtain information on a waiting position of a person present in a waiting area in which the customer is able to wait; a second person information obtainer configured or programmed to obtain second person information for identifying the person; a comparer configured or programmed to compare the first person information with the second person information; and an output section configured or programmed to, in response to the first person information matching the second person information, output information on a correspondence between the order and the waiting position.

### CROSS-REFERENCE TO RELATED APPLICATION

The present application claims the benefit of priority to Japanese Patent Application No. 2025-032738 filed on Mar. 3, 2025, the entire contents of which are hereby incorporated herein by reference.

### BACKGROUND OF THE INVENTION

### Field of the Invention

The present disclosure relates to an order processing system and an order processing method.

### Description of the Related Art

Recent years have seen increasing automation in, for example, restaurants due to such factors as labor shortages and soaring labor costs. While store staffers used to take orders from customers face to face, more and more stores now ask customers to use terminals to order items without the intervention of staffers. This often makes it difficult for store staffers to find out where customers are waiting. Stores may use, for example, table locators (https://paymentnavi.com/paymentnews/124754.html) to find out where customers are waiting.

Table locators are based on an indoor positioning technology involving Bluetooth (registered trademark [hereinafter the same]) to allow staffers to find out the waiting position of a customer on the basis of the position of a table locator in the store. If, however, a customer receives an unintended table locator, for instance, a store staffer may be unable to provide the customer with the ordered item as a result of the wrong correspondence between the order and the table locator. Further, table locators may become, for example, lost, damaged, or out of charge, they are used and managed with store staffers' effort. There is a room for improvement to reduce staffers' effort and allow staffers to easily find out where customers are waiting.

The present disclosure has an object of providing an order processing system and an order processing method each of which has a simple configuration and allows staff to easily find out where customers are waiting.

### SUMMARY OF THE INVENTION

To attain the above object, an order processing system as a first aspect of the present disclosure includes:
an order receiver configured or programmed to receive an order from a customer;
a first person information obtainer configured or programmed to obtain first person information for identifying the customer;
a position information obtainer configured or programmed to obtain information on a waiting position of a person present in a waiting area in which the customer is able to wait;
a second person information obtainer configured or programmed to obtain second person information for identifying the person;
a comparer configured or programmed to compare the first person information with the second person information; and
an output section configured or programmed to, in response to the first person information matching the second person information, output information on a correspondence between the order and the waiting position.

As an embodiment of the present disclosure, the order processing system may be further configured such that
the first person information obtainer is configured or programmed to obtain facial features of the customer which is the first person information,
the second person information obtainer is configured or programmed to obtain facial features of the person which is the second person information, and
the comparer is configured or programmed to compare the facial features of the customer with the facial features of the person.

As an embodiment of the present disclosure, the order processing system may further include:
a notifier configured or programmed to, on a basis of the correspondence on which the output section has outputted information, provide a notification of the waiting position as a destination to which to bring an article corresponding to the order.

As an embodiment of the present disclosure, the order processing system may further include:
a determiner configured or programmed to determine a waiting status indicative of whether the customer is waiting at or away from the waiting position,
wherein the notifier is configured or programmed to provide a notification of the waiting status as a result of the determination by the determiner.

As an embodiment of the present disclosure, the order processing system may be further configured such that
the output section is configured or programmed to output information on a no-match position as a waiting position of a person for which the first person information does not match the second person information.

As an embodiment of the present disclosure, the order processing system may further include:
a notifier configured or programmed to provide a notification of the no-match position on which the output section has outputted information.

As an embodiment of the present disclosure, the order processing system may further include:
a conveyor configured or programmed to, on a basis of the correspondence on which the output section has outputted information, convey an article corresponding to the order to the waiting position.

To attain the above object, an order processing method as a second aspect of the present disclosure is an order processing method performed in an order processing system, the order processing method including:
receiving an order from a customer;
obtaining first person information for identifying the customer;
obtaining information on a waiting position of a person present in a waiting area in which the customer is able to wait;
obtaining second person information for identifying the person;
comparing the first person information with the second person information; and
in response to the first person information matching the second person information, outputting information on a correspondence between the order and the waiting position.

The present disclosure provides an order processing system and an order processing method each of which has a simple configuration and allows staff to easily find out where customers are waiting.

The above-mentioned and other embodiments, procedures, features, and effects of the present disclosure will be more apparent from the following detailed description of the embodiments with reference to the drawings.

### BRIEF DESCRIPTION OF THE DRAWINGS

FIG. 1 is a diagram illustrating an example of how devices of an order processing system are laid out in a restaurant.

FIG. 2 is a block diagram illustrating how an order processing system is configured.

FIG. 3 is a flowchart of how an order processing system processes an order.

FIG. 4 is a diagram illustrating an example screen that shows the correspondence between orders and waiting positions.

FIG. 5 is a block diagram illustrating how an order processing system is configured as an alternative embodiment.

FIG. 6 is a flowchart of how an order processing system processes an order for an alternative embodiment.

### DETAILED DESCRIPTION OF THE PREFERRED EMBODIMENTS

### How Devices of Order Processing System are Laid Out in Restaurant

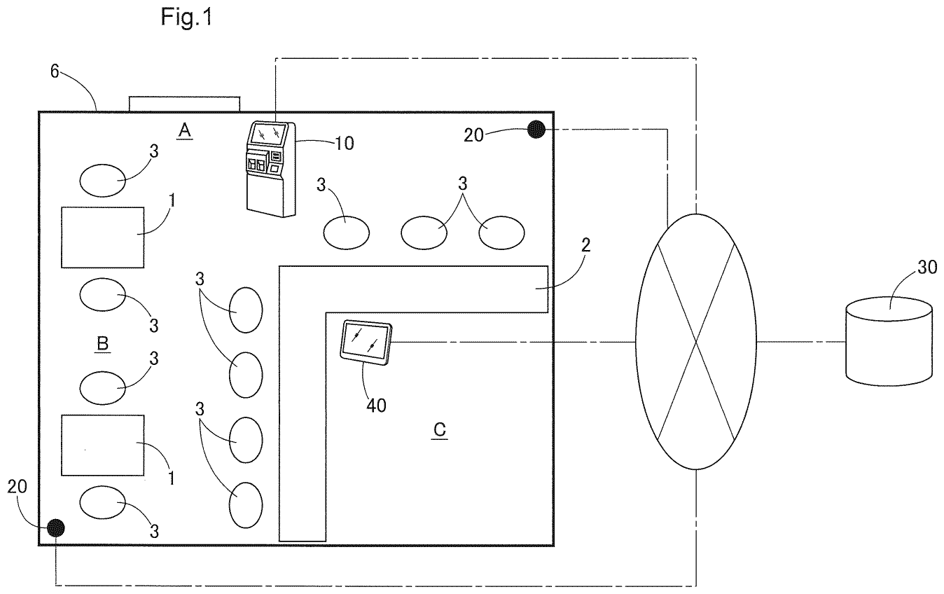

FIG. 1 illustrates an example restaurant such as a ramen noodle restaurant with an entrance A, a dining area B, and a kitchen C in which staff and others (hereinafter referred to simply as “staff” or “staffer”) are present at all times. The restaurant has in the dining area B two tables 1, one long table 2, and two or more chairs 3 adjacent to the tables 1 and the long table 2.

The present disclosure provides an order processing system including an order receiving device 10, image capturing devices 20, a management computer 30, and a tablet terminal 40. The order receiving device 10 is at the entrance A. The two image capturing devices 20 are in the dining area B. The management computer 30 is at, for example, the restaurant operations headquarters or a data center of the service provider. The tablet terminal 40 is in the kitchen C. The order processing system may alternatively include a single image capturing device 20 in the dining area B.

The order receiving device 10, the image capturing devices 20, and the tablet terminal 40 are connected to and capable of communicating with the management computer 30 over, for example, a wide-area network such as a broadband internet communications network based on optical-fiber cables or mobile communications systems (for example, 4G or 5G).

The management computer 30 may alternatively be in the restaurant, in which case the management computer 30, the order receiving device 10, the image capturing devices 20, and the tablet terminal 40 may be connected to and capable of communicating with one another by means of, for example, an Ethernet (registered trademark) communication in conformity with a communications standard such as IEEE 802 or a wireless communication such as Bluetooth or Wi-Fi.

An incoming restaurant customer uses the order receiving device 10 to order and pay for a food item (and/or a drink [hereinafter the same]). The payment may be in the form of an input of money (cash) into the order receiving device 10 or a cashless payment such as an electronic payment (for example, a payment with a credit card, a debit card, a prepaid card, or a smartphone). After the payment, the customer sits on a chair 3. In response to the payment, a cook or a staffer prepares the ordered food item in the kitchen C. Then, a staffer brings the food item to the customer in the dining area B. The customer eats the food item and then leaves the restaurant.

At conventional restaurants, staffers would take orders directly from customers sitting on chairs 3 in the dining area B while distinguishing the customers with use of, for example, table numbers or counter numbers. This would allow staffers to easily find out which food item to bring to which customer. However, as customers now order food items with use of an order receiving device and move to seats that they like, restaurant staffers are having a hard time finding which order belongs to which customer. This issue is especially apparent when staffing of restaurants is saved due to economic factors such as labor shortages and soaring labor costs.

The above issue may be solved as follows: A customer receives a table locator when ordering a food item with an order receiving device; the customer waits with the table locator in the dining area; and a staffer brings the food item to the customer and recovers the table locator. Table locators may, however, become lost or damaged. Further, the restaurant may need to manage the table locators by, for example, charging or replacing the built-in battery. Restaurants want to avoid having to ask customers to have an extra object such as table locators. In view of the above, the order processing system of the present disclosure is configured to output information on the correspondence between (i) each order that the order receiving device has received from a customer and (ii) the position at which the customer is waiting after ordering a food item.

### Configuration of Order Processing System

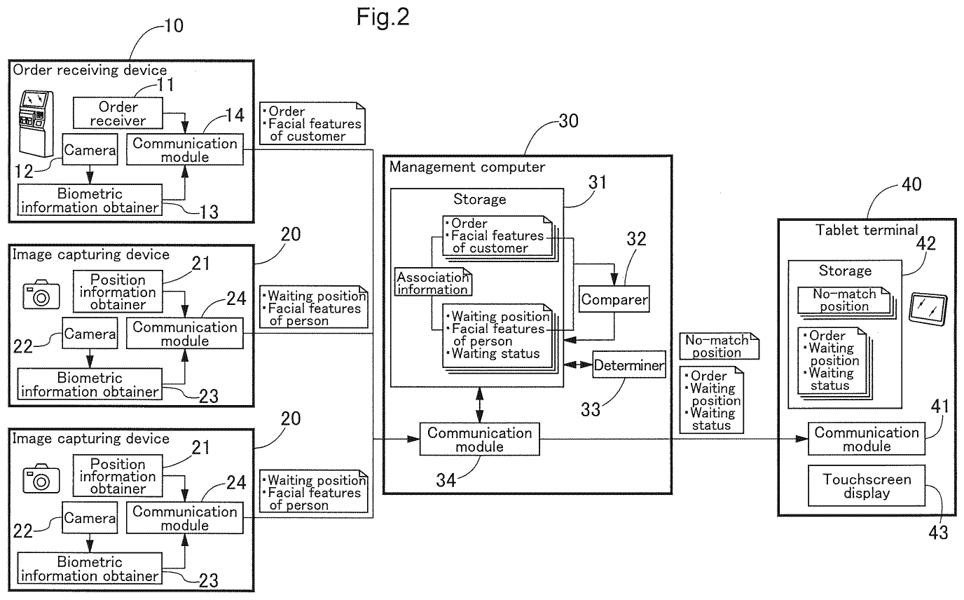

FIG. 2 is a block diagram illustrating the order processing system. The order receiving device 10, when receiving an order from a customer, captures an image of the customer's face and extracts facial features from the image. The order receiving device 10 transmits to the management computer 30 information on the order and the facial features that the order receiving device 10 has extracted. Either of the image capturing devices 20 captures an image of a person (as distinguished herein from the term “customer”) in the dining area B and extracts the position at which the person is waiting and their facial features from the image. The image capturing device 20 transmits to the management computer 30 information on the position at which the person is waiting and their facial features that the image capturing device 20 has extracted.

The management computer 30 compares the facial features from the order receiving device 10 with those from the image capturing devices 20. If the former match the latter, the management computer 30 transmits to the tablet terminal 40 information on the correspondence between the order and the waiting position. The tablet terminal 40 then displays a screen (for example, a list) that shows the correspondence between each order from a customer (for example, each order number and food item ordered) and the position at which the customer is waiting (for example, the table number or counter number).

The order receiving device 10, the image capturing devices 20, the management computer 30, and the tablet terminal 40 each include a non-volatile memory (not illustrated in the drawings) configured to store computer programs and a processor (not illustrated in the drawings) configured to execute the programs, and are each capable of performing various control operations in accordance with control programs. The processor may be in the form of a central processing unit (CPU), a field-programmable gate array (FPGA), a graphics processing unit (GPU), an application-specific integrated circuit (ASIC), an application-specific standard product (ASSP), or a combination of two or more selected from the above circuits. The order receiving device 10, the image capturing devices 20, the management computer 30, and the tablet terminal 40 each perform various functions in response to the processor executing the programs, which may be in the form of, for example, executable programs generated by a compiler and a linker or program code sequentially executable by an interpreter.

The order receiving device 10 includes an order receiver 11, a camera 12, a biometric information obtainer 13, and a communication module 14. The biometric information obtainer 13 is an unlimited example of “first person information obtainer”.

For instance, the order receiving device 10 includes a touchscreen display configured to display a list of food items. In response to a customer tapping on a food item to select it from among the list, the order receiver 11 receives the order, and the camera 12 captures an image of the customer's face. The camera 12 is in the form of, for example, an image sensor such as a complementary metal-oxide semiconductor (CMOS) or charge coupled device (CCD) disposed at an upper portion of the front face of the order receiving device 10.

The biometric information obtainer 13 includes a neural network capable of machine learning based on deep learning. Neural networks are known as capable of identifying input-output relationships with nonlinear characteristics through deep learning. In response to receiving an input of an image of a customer captured by the camera 12, the biometric information obtainer 13 extracts facial features of the customer for their identification from the image on the basis of a machined-learned model. The camera 12 may be configured to capture, for example, still images every second or moving images at ten or more frames per second. The facial features extracted by the biometric information obtainer 13 are example “first person information”.

The communication module 14 is, for instance, connected to an external device wiredly via a LAN port (for example, RJ45) or wirelessly via, for example, Bluetooth or Wi-Fi. The communication module 14 is capable of at least one of a wired connection or a wireless connection to a network. The communication module 14 transmits to the management computer 30 information that associates each order that the order receiver 11 has received from a customer with the facial features of the customer that the biometric information obtainer 13 has extracted.

The image capturing devices 20 each include a position information obtainer 21, a camera 22, a biometric information obtainer 23, and a communication module 24. The biometric information obtainer 23 is an unlimited example of “second person information obtainer”.

The camera 22 is in the form of, for example, an image sensor such as a CMOS or CCD configured to capture an image of a person in the dining area B. The position information obtainer 21 obtains information on the position of the person in the image.

The biometric information obtainer 23 includes a neural network capable of machine learning based on deep learning. In response to receiving an input of an image of a person captured by the camera 22, the biometric information obtainer 23 extracts facial features for identification of the person from the image on the basis of a machined-learned model. The camera 22 may be configured to capture, for example, still images every second or moving images with at 10 or more frames per second. The facial features extracted by the biometric information obtainer 23 are example “second person information”.

The communication module 24 is, for instance, connected to an external device wiredly via a LAN port (for example, RJ45) or wirelessly via, for example, Bluetooth or Wi-Fi. The communication module 24 is capable of at least one of a wired connection or a wireless connection to a network. The communication module 24 transmits to the management computer 30 information that associates the position of each person that the camera 22 has imaged with the facial features of the person that the biometric information obtainer 23 has extracted.

The management computer 30 includes a storage 31, a comparer 32, a determiner 33, and a communication module 34. The communication module 34 is an unlimited example of “output section”.

The communication module 34 is, for instance, connected to an external device wiredly via a LAN port (for example, RJ45) or wirelessly via, for example, Bluetooth or Wi-Fi. The communication module 34 is capable of at least one of a wired connection or a wireless connection to a network. The communication module 34 receives from the communication module 14 information (or data) that associates each order from a customer with the facial features of the customer (hereinafter referred to as “first information”) and from the communication module 24 information (or data) that associates the position of each person with the facial features of the person (hereinafter referred to as “second information”).

The storage 31 is a device configured to store data, and is in the form of, for example, at least one of an EEPROM, a nonvolatile RAM (such as a flash memory or an FeRAM), and a hard disk. The storage 31 temporarily or permanently stores information (or data) that the communication module 34 has received such as first information from the communication module 14 and second information from the communication module 24. The storage 31 also temporarily or permanently stores data generated as a result of a processor executing programs. The storage 31 may be configured to store programs executable by the processor of the management computer 30.

The comparer 32 reads from the storage 31 the facial features from the order receiving device 10 and those from the image capturing devices 20, and compares the former with the latter. If the former match the latter, the comparer 32 records in the storage 31 association information that associates the first information with the second information.

The determiner 33 determines, on the basis of the facial features of each person that the communication module 34 receives from each image capturing device 20 over time, whether the person (or customer) is sitting (or waiting) at or away from the waiting position. The image capturing devices 20 or the determiner 33 may be configured to track the person identified by the biometric information obtainer 23 with use of optical flow, for example, while the camera 22, for example, is imaging the person. In this case, the determiner 33 may be configured to, if the person has moved from the position on which the position information obtainer 21 obtained information, or if the image capturing devices 20 or the determiner 33 has become unable to track the person, determine that the person (or customer) is away from the waiting position.

In response to the comparison by the comparer 32 matching (the facial features from the order receiving device 10 matching those from an image capturing device 20), the communication module 34 transmits to the tablet terminal 40 information on the correspondence between the order and the waiting position. Further, in response to comparison by the comparer 32 not matching (the former not matching the latter), the communication module 34 transmits to the tablet terminal 40 information on a no-match position as the waiting position of the person for which the former did not match the latter.

The tablet terminal 40 includes a communication module 41, a storage 42, and a touchscreen display 43. The touchscreen display 43 is an unlimited example of “notifier”.

The communication module 41 is, for instance, connected to an external device wiredly via, for example, a LAN port (for example, RJ45) or a universal serial bus (USB) or wirelessly via, for example, Bluetooth or Wi-Fi. The communication module 41 is capable of at least one of a wired connection or a wireless connection to a network. The communication module 41 receives from the communication module 34 (i) information (or data) that associates the order from a customer, the waiting position, and a waiting status with one another and (ii) information (or data) on a no-match position described above.

The storage 42 is a device configured to store data, and is in the form of, for example, a nonvolatile RAM (such as a flash memory or an FeRAM). The storage 42 temporarily or permanently stores information (or data) that the communication module 41 has received from the communication module 34 such as (i) information (or data) that associates the order from a customer, the waiting position, and a waiting status with one another and (ii) information (or data) on a no-match position. The storage 42 also temporarily or permanently stores data generated as a result of a processor executing programs. The storage 42 may be configured to store programs executable by a processor.

The touchscreen display 43, on the basis of the correspondence between the order and the waiting position from the communication module 34, displays (or provides a notification of) the waiting position as a destination to which to bring a food item corresponding to the order. The touchscreen display 43 also displays (or provides a notification of) the no-match position from the communication module 34.

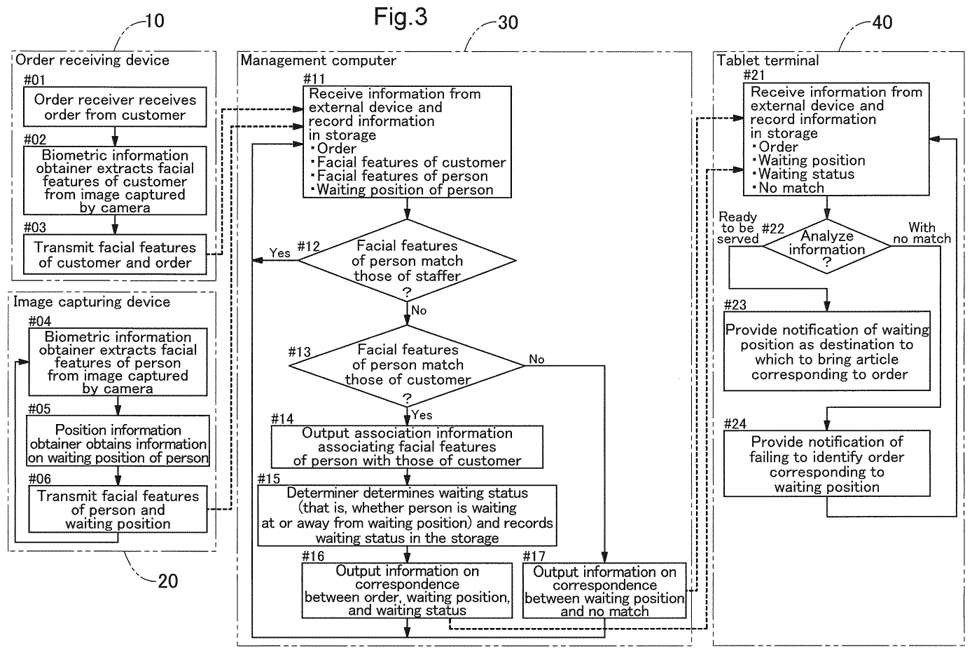

FIG. 3 is a flowchart of how the order processing system of the present disclosure processes an order. First, at the order receiving device 10, in response to the order receiver 11 receiving an order from a customer (step #01), the biometric information obtainer 13 extracts facial features of the customer from an image of the customer that the camera 12 has captured (step #02). The order receiving device 10 may alternatively be configured to perform step #02 before step #01. The communication module 14 transmits to the management computer 30 information on the facial features of the customer and the order (step #03). The order receiving device 10 performs steps #01 to #03 each time the order receiving device 10 receives an order.

Then, at each image capturing device 20, the biometric information obtainer 23 extracts facial features of a person from an image of the person that the camera 22 has captured (step #04). The position information obtainer 21 obtains information on the waiting position of the person (step #05) on the basis of which portion of the image from the camera 22 shows the person or where in the restaurant the camera 22 is disposed. The position information obtainer 21 may be configured to track the person with use of, for example, optical flow while the camera 22, for example, is imaging the person. The image capturing device 20 may alternatively be configured to perform step #05 before step #04. The communication module 24 transmits to the management computer 30 information on the facial features of the person and the waiting position (step #06). Each image capturing device 20 performs steps #04 to #06 periodically (for example, every second).

Then, at the management computer 30, the communication module 34 receives information from an external device and records the information in the storage 31 (step #11). Specifically, the communication module 34 receives first information from the communication module 14 in response to the order receiving device 10 receiving an order from a customer, and records the first information in the storage 31. The communication module 34 also receives second information from the communication module 24 periodically, and records the second information in the storage 31.

The camera 22 may capture an image that incidentally shows a restaurant staffer. The storage 31 stores in advance the facial features of each staffer. In response to the communication module 34 performing step #11, the comparer 32 determines whether the facial features of a person incidentally captured by the camera 22 match those of any staffer stored in the storage 31 (step #12). If the former match the latter (“Yes” in step #12), the comparer 32 determines that the incidentally captured person is a staffer. The process then returns to step #11.

If the former do not match the latter (“No” in step #12), the comparer 32 compares (i) the facial features of the person that the biometric information obtainer 23 of an image capturing device 20 has extracted with (ii) those of the customer that the biometric information obtainer 13 of the order receiving device 10 has extracted. The comparer 32, in other words, determines whether the person imaged by the camera 22 of an image capturing device 20 has an appearance matching that of the customer imaged by the camera 12 of the order receiving device 10 (step #13). If the comparer 32 determined in step #12 that the incidentally captured person is a staffer, the process would not move to step #13. The comparer 32 thus does not compare the facial features of any staffer with those of the customer in step #13. This prevents the comparer 32 from comparing the facial features of the customer from the biometric information obtainer 13 with those of a staffer incidentally captured by the camera 22 and consequently making an erroneous determination.

If the facial features of the person match those of the customer (“Yes” in step #13), the comparer 32 records in the storage 31 association information that associates the former with the latter (step #14). This configuration associates (i) the order that the order receiver 11 of the order receiving device 10 has received from a customer with (ii) the waiting position of the customer on which the position information obtainer 21 of the image capturing device 20 has obtained information. This means that the above configuration informs a staffer of where the customer is waiting after ordering a food item.

As described above, the communication module 34 receives second information from the communication module 24 periodically, and records the second information in the storage 31. The determiner 33 determines the waiting status (that is, whether the person is waiting at or away from the waiting position) on the basis of the facial features of a person that the communication module 34 receives from each image capturing device 20 over time, and records the waiting status in the storage 31 (step #15) as an addition to the second information.

The communication module 34 transmits to the tablet terminal 40 information (data) on the correspondence between the order, the waiting position, and the waiting status (hereinafter referred to as “third information”) (step #16). The data includes information on the order, the waiting position, and the waiting status associated with one another.

If the facial features of the person do not match those of the customer (“No” in step #13), the communication module 34 transmits to the communication module 41 information on a no-match position as the waiting position of the person waiting in the dining area B (step #17), as the order processing system has failed to identify what the person has ordered.

The management computer 30 performs steps #11 to #17 above periodically. The communication module 34 may be configured to perform step #11 by, for example, polling every second or via an interrupt.

Then, at the tablet terminal 40, the communication module 41 receives information from an external device and records the information in the storage 42 (step #21). Specifically, the communication module 41 receives third information and information (or data) on a no-match position periodically from the communication module 34 of the management computer 30, and records the third information and the information on the no-match position in the storage 42.

After step #21, the processor of the tablet terminal 40 analyzes the information that the communication module 41 has received from the communication module 34 and recorded in the storage 42 (step #22). If the processor has determined on the basis of the information that any food item ordered is ready to be served (“Ready to be served” in step #22), the processor causes the touchscreen display 43 to display (or provide a notification of) the waiting position as a destination to which to bring the food item corresponding to the order (step #23). If the processor has determined that the information includes information on a no-match position (“No match” in step #22), the processor causes the touchscreen display 43 to display (or provide a notification of) information to the effect that the processor has failed to identify an order corresponding to the waiting position (step #24).

The tablet terminal 40 performs steps #21 to #24 above periodically. The communication module 41 may be configured to perform step #21 by, for example, polling every second or via an interrupt.

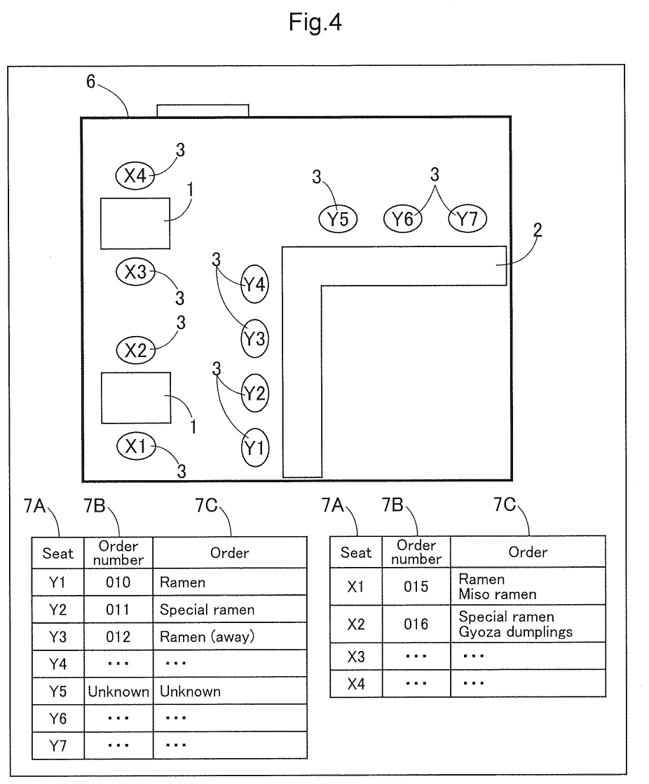

FIG. 4 illustrates an example display screen 5 on the touchscreen display 43 including a map 6 and an order list 7. The map 6 shows a floor plan of the restaurant including chairs 3 with respective signs. The order list 7 is tabulated with a seat column 7A indicative of the chairs 3 with their respective signs, an order number column 7B corresponding to the seat column 7A, and an order item column 7C corresponding to the seat column 7A and the order number column 7B.

The order list 7 associates each sign in the seat column 7A with an order in the order number column 7B and the order item column 7C which order the order receiver 11 of the order receiving device 10 has received. The map 6 and the order list 7 inform a staffer of which customer corresponds to which order number and is waiting for which food item.

The order list 7 shows the term “away” in the order item column 7C if the customer is away from their chair 3, on the basis of the waiting status that the determiner 33 has determined. The order list 7 informs a staffer that a customer is away from their chair 3 (for example, in the restroom). The tablet terminal 40 may be configured to, if a customer has moved from a first chair 3 to a second chair 3, move the corresponding information in the order number column 7B and the order item column 7C from the cells in the row for the first chair 3 to those for the second chair 3.

The order list 7 also shows the term “Unknown” in each of the order number column 7B and the order item column 7C in correspondence with a chair 3 occupied by a person for which the facial features from the order receiving device 10 do not match those from the image capturing device 20. The term indicates a no-match position as the waiting position of the person and may refer to an order that the order receiver 11 has received and that is unassociated with a waiting position on which the position information obtainer 21 has obtained information (hereinafter referred to as “unassociated order”). The tablet terminal 40 may be configured to cause the touchscreen display 43 to display a pop-up list of unassociated orders in response to a staffer touching a portion of the touchscreen display 43 which portion shows the term “Unknown”. If the order list 7 shows any unassociated order, a staffer may move to the chair 3 occupied by the customer for which the order number is unknown, and ask the customer whether the unassociated order belongs to the customer or take an order from the customer.

When a customer leaves the restaurant, the order processing system deletes information on the facial features of the customer for privacy protection. The order processing system may, for instance, include at the entrance A a camera for detecting a leaving customer, and be configured to, if the facial features of a customer imaged by the camera match those of a customer and those of a person in the storage 31, delete those of the customer and those of the person from the storage 31.

The management computer 30 may be configured to delete from the storage 31 the facial features of each customer from the order receiving device 10 in response to a staffer finishing bringing a food item to the customer. In this case, if the management computer 30 deletes the facial features of each customer as above while the image capturing devices 20 keep extracting the facial features of the person (customer), step #13 may return “No” as the management computer 30 performs its periodical process. To avoid such an inconvenience, the management computer 30 may be configured to turn on a flag indicative of a completed order for the facial features of each person that the management computer 30 has received from an image capturing device 20 and recorded in the storage 31. In this case, the management computer 30, for instance, determines in step #12 whether a flag indicative of a completed order is on for the facial features of a person. Step #12 returns “Yes” if such a flag is on. The management computer 30 may be further configured to delete the facial features of a person from the storage 31 in response to detecting on the basis of an image captured by the camera for detecting a leaving customer that the person has left the restaurant.

### Advantages of Embodiments

An order processing system of the present disclosure includes: an order receiver 11 configured to receive an order from a customer; a biometric information obtainer 13 (first person information obtainer) configured or programmed to obtain first person information for identifying the customer; a position information obtainer 21 configured or programmed to obtain information on a waiting position of a person present in a waiting area in which the customer is able to wait; a biometric information obtainer 23 (second person information obtainer) configured or programmed to obtain second person information for identifying the person; a comparer 32 configured or programmed to compare the first person information with the second person information; and a communication module 34 (output section) configured or programmed to, in response to the first person information matching the second person information, output information on a correspondence between the order and the waiting position.

The order processing system includes a biometric information obtainer 13 (first person information obtainer) configured or programmed to obtain first person information for identifying a customer when the customer orders an article, a biometric information obtainer 23 (second person information obtainer) configured or programmed to obtain second person information for identifying a person in a waiting area, a comparer 32 configured or programmed to compare the first person information with the second person information, and a communication module 34 (output section) configured or programmed to, in response to the first person information matching the second person information, output information on a correspondence between the order and the waiting position. The position information obtainer 21 obtains information on the position of a customer who has ordered an article to track the customer even if, for instance, the customer does not carry a table locator. This eliminates the need for store staff to use or manage table locators and allows the staff to easily find out the waiting position of each customer with reduced effort, thereby providing an order processing system that has a simple configuration and allows staff to easily find out where customers are waiting.

The order processing system of the present disclosure may be further configured such that the biometric information obtainer 13 (first person information obtainer) is configured or programmed to obtain facial features of the customer which is the first person information, the biometric information obtainer 23 (second person information obtainer) is configured or programmed to obtain facial features of the person which is the second person information, and the comparer 32 is configured or programmed to compare the facial features of the customer with the facial features of the person.

With the above configuration, the first person information and the second person information are each facial features. This eliminates the need for a customer to hold an object for their identification and thereby eliminates the risk of, for instance, losing such an object.

The order processing system of the present disclosure may further include: a touchscreen display 43 (notifier) configured or programmed to, on a basis of the correspondence on which the communication module 34 (output section) has outputted information, provide a notification of the waiting position as a destination to which to bring an article (which may be a food item) corresponding to the order.

The above configuration allows staffers to easily find out the waiting position of a customer as a destination.

The order processing system of the present disclosure may further include: a determiner 33 configured or programmed to determine a waiting status indicative of whether the customer is waiting at or away from the waiting position, wherein the touchscreen display 43 (notifier) is configured or programmed to provide a notification of the waiting status as a result of the determination by the determiner 33.

The above configuration allows staffers to find out in real time whether a customer is waiting at or away from the waiting position and convey the ordered article to the waiting position of the customer at a time convenient for the customer.

The order processing system of the present disclosure may be further configured such that the communication module 34 (output section) is configured or programmed to output information on a no-match position as a waiting position of a person for which the first person information does not match the second person information.

The above configuration allows staffers to easily find out the waiting position of a person for which the first person information does not match the second person information and, for instance, quickly ask a customer who did not order an article appropriately.

The order processing system of the present disclosure may further include: a touchscreen display 43 (notifier) configured or programmed to provide a notification of the no-match position on which the communication module 34 (output section) has outputted information.

The above configuration allows staffers to easily find out the waiting position of a person for which the first person information does not match the second person information.

### Alternative Embodiments

The present disclosure is not limited to the above embodiment as an example. The description below deals with embodiments of the present disclosure as other typical examples.

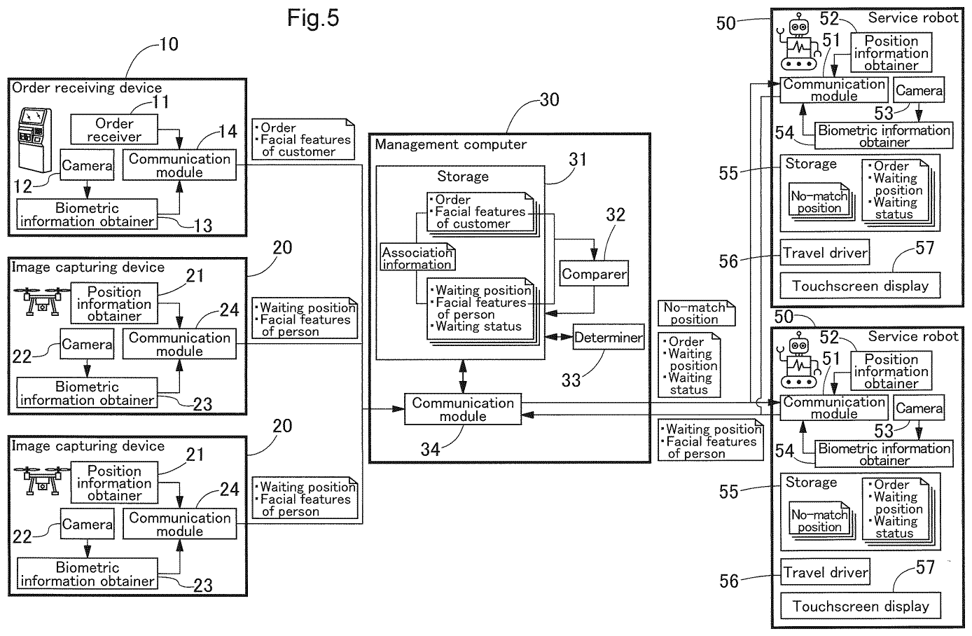

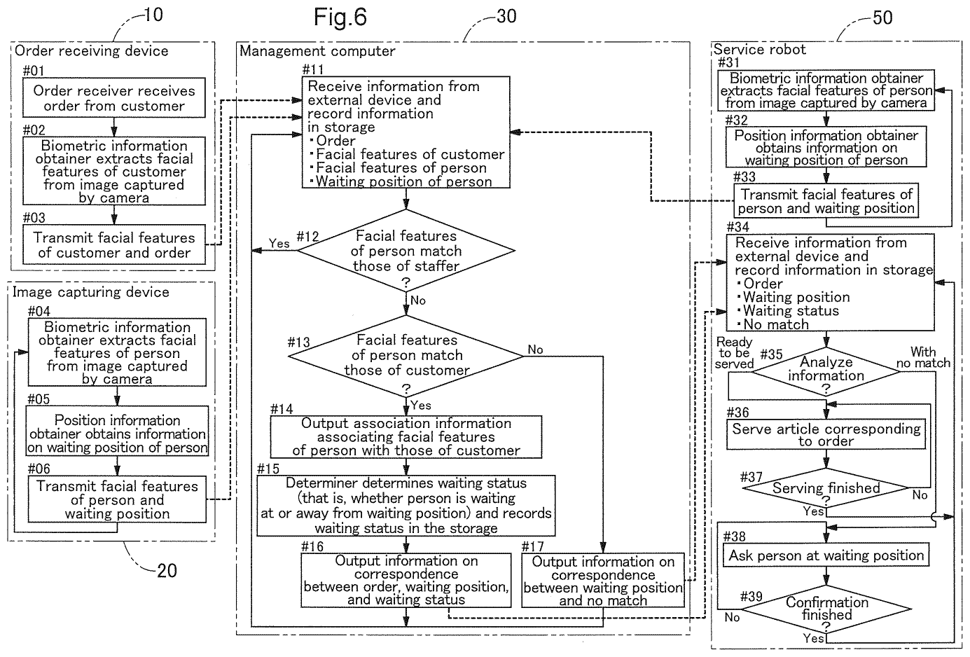

(1) The embodiment described above is configured such that in response to the facial features from the order receiving device 10 matching those from an image capturing device 20, the communication module 34 (output section) transmits to the communication module 41 of the tablet terminal 40 information on the correspondence between the order and the waiting position and that in response to the former not matching the latter, the communication module 34 (output section) transmits to the communication module 41 information on a no-match position as the waiting position of the person for which the former did not match the latter. The present disclosure is, however, not limited to such a configuration; for instance, the order processing system may, as illustrated in FIGS. 5 and 6, include service robots 50 each including a communication module 51 and be configured such that the communication module 34 (output section) transmits information to the communication module 51. The service robots 50 are each an unlimited example of “conveyor”.

As illustrated in FIG. 5, the service robots 50 each include a communication module 51, a position information obtainer 52, a camera 53, a biometric information obtainer 54, a storage 55, a travel driver 56, and a touchscreen display 57. The service robots 50 each include a processor (not illustrated in the drawings) configured to execute computer programs stored in the storage 55, and are each capable of performing various control operations in accordance with control programs. The processor may be in the form of a CPU, a FPGA, a GPU, an ASIC, an ASSP, or a combination of two or more selected from the above circuits. The processor reads programs from the storage 55 and executes the programs for various functions to be performed by the communication module 51, the position information obtainer 52, the camera 53, the biometric information obtainer 54, the travel driver 56, and the touchscreen display 57. The programs may be in the form of, for example, executable programs generated by a compiler and a linker or program code sequentially executable by an interpreter.

The travel driver 56 includes a drive motor and wheels (not illustrated in the drawings) for the service robot 50 to travel in the restaurant. The service robots 50 of the present disclosure each double as an image capturing device 20. The camera 53 is in the form of, for example, an image sensor such as a CMOS or CCD configured to capture an image of a person in the dining area B. The position information obtainer 52 obtains information on the position of the person in the image. As the service robots 50 each use its travel driver 56 to move in the restaurant, the position information obtainer 52 may be configured to obtain information on the position of a person imaged by the camera 53 with use of (i) a publicly known indoor positioning technology such as Wi-Fi-based positioning, beacon-based positioning, UWB-based (Ultra-Wide Band-based) positioning, or SLAM (Simultaneous Localization and Mapping) or (ii) a publicly known positioning technology based on a global navigation satellite system (GNSS) such as GPS, QZSS, Galileo, GLONASS, or BeiDou.

The biometric information obtainer 54 includes a neural network capable of machine learning based on deep learning. Neural networks are known as capable of identifying input-output relationships with nonlinear characteristics through deep learning. In response to receiving an input of an image of a person captured by the camera 53, the biometric information obtainer 54 extracts facial features of the person for their identification from the image on the basis of a machined-learned model. The camera 53 may be configured to capture, for example, still images every second or moving images at ten or more frames per second. The biometric information obtainer 54 is an unlimited example of “second person information obtainer”.

The communication module 51 is connected to an external terminal wirelessly via, for example, Bluetooth or Wi-Fi. The communication module 51 transmits to the management computer 30 information that associates the position of each person that the camera 53 has imaged with the facial features of the person that the biometric information obtainer 54 has extracted. The communication module 51 receives third information and information (or data) on a no-match position from the communication module 34 of the management computer 30, and records the third information and the information on the no-match position in the storage 55. This allows the service robot 50 to control its travel driver 56 and bring an ordered food item to a customer on the basis of third information. The touchscreen display 57 displays, for example, various information items, touch buttons, and selection buttons as necessary. If, for instance, the storage 55 stores information (or data) on a no-match position, the service robot 50 controls its travel driver 56 to move to the customer and ask the customer whether the unassociated order belongs to the customer.

FIG. 6 is a flowchart of how the order processing system processes an order with use of a service robot 50. The description below deals with only steps #31 and later with reference to FIG. 6 and omits to deal with steps #01 to #03 at the order receiving device 10, steps #04 to #06 at an image capturing device 20, and steps #11 to #17 at the management computer 30, as those steps are as described above with reference to FIG. 3.

Steps #31 to #33 are basically equivalent to steps #04 to #06 that each image capturing device 20 performs. The biometric information obtainer 54 extracts facial features of a person from an image of the person that the camera 53 has captured (step #31). The position information obtainer 52 obtains information on the waiting position of the person (step #32) on the basis of which portion of the image from the camera 53 shows the person or with use of at least one of an indoor positioning technology and a GNSS positioning technology. The position information obtainer 52 may be configured to track the person with use of, for example, optical flow while the camera 53, for example, is imaging the person. The service robot 50 may alternatively be configured to perform step #32 before step #31. The communication module 51 transmits to the management computer 30 information on the facial features of the person and the waiting position (step #33). The service robot 50 performs steps #31 to #33 periodically (for example, every second).

Steps #34 to #39 are related to bringing a food item to a customer and asking a customer. The communication module 51 receives information from an external device and records the information in the storage 55 (step #34). Specifically, the communication module 51 receives third information and information (or data) on a no-match position periodically from the communication module 34 of the management computer 30, and records the third information and the information on the no-match position in the storage 55.

After step #34, the processor of the service robot 50 analyzes the information that the communication module 51 has received from the communication module 34 and recorded in the storage 55 (step #35). If the processor has determined on the basis of the information that any food item ordered is ready to be served (“Ready to be served” in step #35), the service robot 50 holds the food item and controls its travel driver 56 to move toward the waiting position as a destination to which to bring the food item corresponding to the order (step #36). In response to arriving at the waiting position, the service robot 50 stops there and causes the touchscreen display 57 and a loudspeaker for audio guidance (not illustrated in the drawings) to send out a message that prompts the customer to receive the food item. The processor then determines whether the service robot 50 has finished serving the food item (step #37) on the basis of, for example, detection by a sensor (not illustrated in the drawings) or whether the customer has touched a confirmation button on the touchscreen display 57. If the service robot 50 has not finished serving the food item (“No” in step #37), the service robot 50 repeats steps #36 and #37. If the service robot 50 has finished serving the food item (“Yes” in step #37), the process returns to step #34. The service robot 50 may be configured to return to a predetermined position at this stage.

If the processor of the service robot 50 has determined in step #35 that the information stored in the storage 55 includes information on a no-match position (“No match” in step #35), the service robot 50 moves toward the no-match position as the waiting position of the person for which the facial features from the order receiving device 10 did not match those from the image capturing device 20. In response to arriving at the no-match position, the service robot 50 stops there and asks the person (who may be the right customer) about their order (step #38). If the information stored in the storage 55 includes information on an order that the order receiver 11 has received and that is unassociated with a waiting position on which the position information obtainer 21, 52 has obtained information, the service robot 50 moves to the chair 3 occupied by the customer for which the order number is unknown and causes the touchscreen display 57 to show a confirmation screen that asks the customer whether the unassociated order belongs to the customer or an order screen for taking an order from the customer. The processor then determines whether the service robot 50 has finished the confirmation (step #39) on the basis of, for example, detection by a sensor (not illustrated in the drawings) or whether the customer has touched a confirmation button on the touchscreen display 57. If the service robot 50 has not finished the confirmation (“No” in step #39), the service robot 50 repeats steps #38 and #39. If the service robot 50 has finished the confirmation (“Yes” in step #39), the process returns to step #34. The service robot 50 may be configured to return to a predetermined position at this stage.

The service robot 50 performs steps #34 to #39 above periodically. The communication module 51 may be configured to perform step #34 by, for example, polling every second or via an interrupt.

The conveyor for the present disclosure is not limited to a service robot 50 and may be a roller conveyor, a belt conveyor, or a linear drive conveying device each configured to convey, for example, a food item to each table.

(2) The present disclosure also relates to an order processing method performed in an order processing system. The order processing method includes receiving an order from a customer; obtaining first person information (for example, facial features) for identifying the customer; obtaining information on a waiting position of a person present in a waiting area in which the customer is able to wait; obtaining second person information (for example, facial features) for identifying the person; comparing the first person information with the second person information; and in response to the first person information matching the second person information, outputting information on a correspondence between the order and the waiting position. With reference to FIGS. 3 and 6, step #01 corresponds to the receiving; step #02 corresponds to the obtaining of first person information; step #05 corresponds to the obtaining of information on a waiting position; step #04 corresponds to the obtaining of second person information; step #13 corresponds to the comparing; and step #16 corresponds to the outputting. The method includes obtaining first person information for identifying a customer when the customer orders an article, obtaining second person information for identifying a person in a waiting area, comparing the first person information with the second person information, and in response to the first person information matching the second person information, outputting information on the correspondence between the order and the waiting position. The method obtains information on the position of a customer who has ordered an article to track the customer even if, for instance, the customer does not carry a table locator. This eliminates the need for store staff to use or manage table locators and allows the staff to easily find out the waiting position of each customer with reduced effort, thereby providing an order processing method that has a simple configuration and allows staff to easily find out where customers are waiting. The order processing method may be in the form of a computer program.

(3) The image capturing devices 20 may each be in the form of, for example, an unmanned aerial vehicle (or a drone) as illustrated in FIG. 5. The image capturing devices 20 may, in this case, be each configured to fly around over the dining area B in the restaurant and capture an image of a person below with use of the camera 22. This configuration is applicable to, for example, a large-scale restaurant, a food court in a shopping mall, a beer garden, a barbecue site, and a cruise ship. If the image capturing devices 20 are each an unmanned aerial vehicle, the position information obtainer 21 may be configured to obtain information on the position of a person imaged by the camera 22 with use of (i) a publicly known indoor positioning technology such as Wi-Fi-based positioning, beacon-based positioning, UWB-based positioning, or SLAM or (ii) a publicly known positioning technology based on a global navigation satellite system (GNSS) such as GPS, QZSS, Galileo, GLONASS, or BeiDou. The image capturing devices 20 may alternatively be each in the form of a camera wearable by a staffer.

(4) The embodiment described above is configured such that the position information obtainer 21 obtains information on the waiting position of a person present in a waiting area in which a customer is able to wait. The waiting area is not limited to a chair 3 and may be, for example, an area for a customer to wait to receive a take-out food item or a kid's room.

(5) The order receiving device 10 may be in the form of, for example, a combination of a tablet computer and a contactless payment terminal. The order receiving device 10 may, in this case, be configured such that the tablet computer contains an order receiver 11, a camera 12, a biometric information obtainer 13, and a communication module 14 and that the contactless payment terminal is connected to and capable of communicating with the tablet computer. The order receiving device 10 may alternatively be in the form of a customer's smartphone. The order receiving device 10 may, in this case, be configured such that the smartphone contains an order receiver 11, a camera 12, a biometric information obtainer 13, and a communication module 14 as well as a payment application installed for cashless payment. The smartphone may also enable mobile ordering.

(6) The embodiment described above is configured such that the first person information obtainer (that is, the biometric information obtainer 13) is configured or programmed to extract facial features of a customer as first person information and that the second person information obtainer (that is, the biometric information obtainer 23) is configured or programmed to extract facial features of a person as second person information. The present disclosure is, however, not limited to such a configuration; the first person information and the second person information may each include information on at least one of, for example, facial features, iris, fingerprint, voice print, clothes, skeletal structure, and whether the customer or person is with a child or children.

(7) The order processing system as the above embodiment includes a tablet terminal 40 in the kitchen C. The present disclosure is, however, not limited to such a configuration; the order processing system may alternatively include a tablet terminal 40 for each staffer to carry.

(8) The embodiment described above includes a touchscreen display 43 as a notifier configured to provide a notification of, for example, a waiting position or a no-match position. The notifier is, however, not limited to the touchscreen display 43 and may be in the form of, for example, a loudspeaker for audio guidance, an earphone wearable by a staffer, or eyeglasses each including a lens with a notification display embedded in the surface.

(9) The biometric information obtainers 13, 23, and 54 may all be included in the management computer 30 instead of the order receiving device 10, the image capturing devices 20, and the service robots 50. In this case, the biometric information obtainers 13, 23, and 54 in the management computer 30 analyze images captured by the respective cameras 12, 22, and 53 to obtain first person information and second person information.

(10) The management computer 30 may be integral with the tablet terminal 40. The order processing system may, in this case, be configured such that the tablet terminal 40 contains a storage 31, a comparer 32, and a determiner 33 and that the communication modules 34 and 41 are integral with each other for wireless communication. The touchscreen display 43 may, in this case, double as the output section and the notifier. Further, the order receiving device 10 may be integral with the management computer 30. The order processing system may, in this case, be configured such that the order receiving device 10 contains a storage 31, a comparer 32, and a determiner 33 and that the communication modules 14 and 34 are integral with each other.

(11) The embodiment described above involves a food item as an example “article” for the present disclosure. The article may, for instance, cover a novelty item accompanying a food item or be in the form of a medication prepared on the basis of a prescription or a fragrance produced from a blend of ingredients.

(12) The embodiment described above is configured such that when a customer leaves the restaurant, the order processing system deletes information on the facial features of the customer (that is, the first person information and the second person information). The order processing system may alternatively be configured to delete the first person information and the second person information, for instance, after a customer leaves the restaurant and when a staffer clears the table 1 used by the customer or the area of the long table 2 which area was used by the customer. The order processing system may alternatively be configured to (i) allow at least one of the first person information and the second person information to be used for analysis of results of market research before deleting the information and (ii) keep information other than the first person information and the second person information as a record of the market research.

The configurations disclosed in the above embodiments (including the other embodiments, the same applies hereinafter) may be implemented by being combined with configurations disclosed in other embodiments as long as no contradiction arises. The embodiments disclosed in the present specification are examples, and embodiments of the present disclosure are not limited to the above embodiments. The disclosed embodiments can be modified as appropriate within a scope not departing from the object of the present disclosure.

The present disclosure is applicable to an order processing system and an order processing method.

What is claimed is:

1. An order processing system, comprising:
an order receiver configured or programmed to receive an order from a customer;
a first person information obtainer configured or programmed to obtain first person information for identifying the customer;
a position information obtainer configured or programmed to obtain information on a waiting position of a person present in a waiting area in which the customer is able to wait;
a second person information obtainer configured or programmed to obtain second person information for identifying the person;
a comparer configured or programmed to compare the first person information with the second person information; and
an output section configured or programmed to, in response to the first person information matching the second person information, output information on a correspondence between the order and the waiting position.

2. The order processing system according to claim 1, wherein
the first person information obtainer is configured or programmed to obtain facial features of the customer which is the first person information,
the second person information obtainer is configured or programmed to obtain facial features of the person which is the second person information, and
the comparer is configured or programmed to compare the facial features of the customer with the facial features of the person.

3. The order processing system according to claim 1, further comprising:
a notifier configured or programmed to, on a basis of the correspondence on which the output section has outputted information, provide a notification of the waiting position as a destination to which to bring an article corresponding to the order.

4. The order processing system according to claim 3, further comprising:
a determiner configured or programmed to determine a waiting status indicative of whether the customer is waiting at or away from the waiting position,
wherein the notifier is configured or programmed to provide a notification of the waiting status as a result of the determination by the determiner.

5. The order processing system according to claim 1, wherein
the output section is configured or programmed to output information on a no-match position as a waiting position of a person for which the first person information does not match the second person information.

6. The order processing system according to claim 5, further comprising:
a notifier configured or programmed to provide a notification of the no-match position on which the output section has outputted information.

7. The order processing system according to claim 1, further comprising:
a conveyor configured or programmed to, on a basis of the correspondence on which the output section has outputted information, convey an article corresponding to the order to the waiting position.

8. An order processing method performed in an order processing system,
the method comprising:
receiving an order from a customer;
obtaining first person information for identifying the customer;
obtaining information on a waiting position of a person present in a waiting area in which the customer is able to wait;
obtaining second person information for identifying the person;
comparing the first person information with the second person information; and
in response to the first person information matching the second person information, outputting information on a correspondence between the order and the waiting position.
